(19) United States
(12) Patent Application Publication
(10) Pub. No.: US 2017/0118145 A1
(43) Pub. Date: Apr. 27, 2017

(54) METHOD OF USING EMOJI TO CONTROL AND ENRICH 3D CHAT ENVIRONMENTS

(71) Applicant: FUTUREFLY LTD., Helsinki (FI)

(72) Inventors: Toni Aittoniemi, Kellokoski (FI); Oskari Häkkinen, Espoo (FI); Miika Viljami Pylkkö, Helsinki (FI); Pietari Päivänen, Helsinki (FI); Heikki Juhani Sinivaara, Helsinki (FI)

(21) Appl. No.: 15/298,371

(22) Filed: Oct. 20, 2016

Related U.S. Application Data
(60) Provisional application No. 62/244,299, filed on Oct. 21, 2015.

(51) Int. Cl. H04L 12/58; H04L 29/06

(52) U.S. Cl. CPC H04L 51/04; H04L 51/10; H04L 65/403

(57) ABSTRACT

A sent message including at least one animation-triggering token (EMOJI, hashtag or free text) is parsed into a message Presentation in the 3D chat space by adding animations corresponding to each token in the message. The message Presentation is sent to and displayed by the receiving party, including playing the animations corresponding to the tokens. The message is parsed by splitting the message into a list of tokens. Each token is associated with a corresponding animation. The message Presentation is formed of the corresponding animations. The message Presentation is displayed in accordance with the animation blocks contained. If the message includes a weather effect, the weather effect animation is played. If the message includes an avatar animation, animation layers are applied to corresponding avatar bones and the avatar animation is played. If the message includes EMOJI enrichments, the enrichments are converted into particle effects and played.

### BACKGROUND OF THE INVENTION

1. Field of the Invention

The present invention relates to 3D chat environments and more particularly, to a method of using emoji to control and enrich 3D chat environments.

2. Description of Prior Art Including Information Disclosed Under 37 CFR 1.97 and 1.98

An Emoji is a graphic symbol that represents an idea or concept in an electronic message. Emoji are used much like a pictorial representation provided to express a person's feelings or mood and exist in various genres, including facial expressions, common objects, places and types of weather, and animals.

Emoji originated on Japanese mobile phones in the late 1990s. Emoji have become increasingly popular worldwide since their international inclusion in Apple's iPhones, which was followed by similar adoption by Android and other mobile operating systems.

The present invention takes the use of emoji from being simply an expression of an emotion or idea to a new level in which the emoji included in a message can actually control an avatar and/or the background in which the avatar is presented to substantially enhance the experience of individuals messaging in a 3D chat space.

### BRIEF SUMMARY OF THE INVENTION

The present invention relates to a method of using EMOJI to control and enrich 3D chat environments. The method includes the steps of: constructing and displaying a 3D chat space within which a first party and a second party may communicate; parsing a message entered by one party into a message Presentation in the 3D chat space including at least one animation-triggering token (EMOJI, hashtag or free text) by adding an animation corresponding to the token into the message Presentation; sending the message Presentation to the receiving party; and displaying the message Presentation to the receiving party, including playing the animation corresponding to the token.

The method further includes the step of displaying the message Presentation to the sending party, including playing animation corresponding to the token, before the message Presentation is sent to the receiving party.

The step of parsing a message comprises the steps of: splitting the message from the sending party into a list of tokens; associating each of the tokens on the list with a corresponding animation; forming the message Presentation of the corresponding animations for each of the tokens on the list; and displaying the message Presentation.

The step of displaying the message presentation includes the steps of: determining if the animation block in the message Presentation includes a weather effect; and if the animation block in the message Presentation includes a weather effect, playing the weather effect animation.

The step of displaying the message Presentation also includes the steps of: determining if the animation includes an avatar animation; and if the animation includes an avatar animation, applying animation layers to corresponding avatar bones and playing the avatar animation.

The step of displaying the message presentation also includes determining if the animation includes EMOJI enrichments; and if the animation includes EMOJI enrichments, converting the EMOJI enrichments into particle effect animations and playing the particle effect animations.

The method further includes the steps of: initiating a chat by the first party and creating a chat room.

The method further includes the steps of: determining if the receiving party is still in the chat after the message Presentation is sent; and if the receiving party is not still in the chat, waiting until the receiving party returns to the chat before displaying the message Presentation to the receiving party.

The method of parsing the message into a message Presentation further includes the steps of: determining if the token includes an animation-triggering EMOJI or hashtag; and if the token includes an animation-triggering EMOJI or hashtag; adding animation corresponding to the EMOJI or hashtag to the message Presentation.

The method of parsing a message into a message Presentation further includes the steps of: determining if the token includes an EMOJI-customizable hashtag; and if the token includes an EMOJI-customizable hashtag, determining if the EMOJI-customizable hashtag is followed by an EMOJI; if the customizable hashtag is followed by an EMOJI, adding corresponding EMOJI-customizable-animation to the message Presentation.

The method of parsing a message into a message Presentation further includes the step of applying random EMOJI as parameters, if the customizable hashtag is not followed by an EMOJI.

The method of parsing a message into a message Presentation further includes the steps of: determining if the token includes free text; and if the token includes free text, determining if the free text is followed by an EMOJI; and if the free text is followed by an EMOJI, adding animation corresponding to the EMOJI to the message Presentation.

The method of parsing a message into a presentation further includes the steps of: determining if the free text includes a facial expression, and if the free text includes a facial expression, applying corresponding facial layers to the avatar talk animation and adding the avatar talk animation to message Presentation.

The method further includes the step of adding the avatar talk animation to message Presentation if the free text is not followed by an EMOJI.

The method further includes the step of removing the lighting and background altering tokens from the list and adding same into the message Presentation.

The method further includes the steps of splitting the message from the sending party into a list of tokens; associating each of the tokens on the list with a corresponding animation; and forming the message Presentation of the corresponding animations for each of the tokens on the list.

### BRIEF DESCRIPTION OF THE SEVERAL VIEWS OF DRAWINGS

To these and to such other objects that may hereinafter appear, the present invention relates to a method of using emoji to control and enrich 3D chat environments as described in detail in the following specification and recited in the annexed claims, taken together with the accompanying drawings in which:

FIG. 1 is a flow chart of an overview of the messaging process using our invention;

FIG. 2 is a flow chart of the portion of the messaging process in which a message is parsed into a message Presentation in 3D chat space; and

FIG. 3 is a flow chart of the portion of the messaging process in which a message's Presentation in 3D space is displayed.

### DETAILED DESCRIPTION OF THE INVENTION

A 3D chat environment, within which the present invention controls and enriches with emoji, is defined as:
Camera
Perspective mapping of simulated 3-dimensional assets to a view plane on the display surface. In particular, avatars representing the chat participants.
Background image
Lighting conditions+shadows cast by 3-dimensional assets

The avatars are 3-dimensional representations of humanoid characters, customized with various shapes of meshes (such as hairstyles) and textures (such as clothing patterns). They are animated in a standard manner: by manipulating a skeleton onto which the meshes making up the avatar are connected.

We use particle effects to present emoji in the 3D chat environment. A particle effect has
Starting point (s), either a point in the 3D environment or a bone in the avatar skeleton (which in itself may be moving in the 3D space)
Velocity curve which the particles follow (in relation to the starting point)
Lifetime (after which a particle is removed)

A certain number of particles are emitted from the starting point, along the velocity curve, slightly randomized (timing between particles, the exact velocity curve). In our invention, emoji in chat messages are used as the particles.

The 3D Characters Which are Used:
(a) have a defined amount of simulated representations of humanoid characters rendered in simulated illumination. Simulation quality is good enough for the characters to appear believably engaging with their environment and each other.
(b) humanoid characters are animated, that is, appear as to be moving in the 3D space.
(c) characters are animated by a hierarchical tree of 3-dimensional nodes (4×4 matrices) representing position, rotation and scale—or alternatively by a point, direction and length of vector in 3D-space—forming a representation of a humanoid biped skeleton when these points are linked in parent-child relationships.
(d) character surface topology is defined by a virtual 3-dimensional surface. Each point in the surface is defined as the space coordinate where inside becomes the outside. Each point is capable of being affected by the movement of the underlying skeleton representation described in the previous point. The amount each point of the surface is affected by the movement of the underlying skeleton is defined by a mathematical equation.
(e) The simulated lighting conditions and color of each surface point are defined by an computer program executed on the graphics system, and the parameters given to it by the main program.

The Character Animation Which is Used:
(a) Moving the skeleton moves the characters by moving the representation of their surface as described in ‘3D Characters’ section above.
(b) The skeleton is animated by defining how the positon, rotation, and scale of each node (points or matrix transforms as above) changes according to time.
(c) The total movement of the skeleton nodes represent the body language and movements of humanoid characters.

Special Effects (Particle Effects) Used Are:
(a) Embedding of non-perspective 2-dimensional images—“particles”—in the 3D chat environment, with movement in the three dimensions The particles have predefined behavior with regard to their velocity in the 3D space, and a limited lifetime: they are removed from the environment after this time-span has expired.
(b) Emitting of particles from a position in the 3D space, which can also be animated.
(c) Linkage to positions animated by character animation.
(d) Different velocity, lifespan and emitting behaviors allow crude approximations of real-world particle behavior (fluids, gases)
(e) Mapping of unicode Emoji-symbols to the 2-dimensional particle images is purposefully non-realistic rendering of real-world simulated velocity behavior can be used for conveying both symbolic value and its linkage with real-world actions.

A selected emoji affects the hierarchical tree of 3D-dimensional nodes to change the position/rotation/scale of the skeleton to animate the avatar in the manner defined by the selected emoji. For example, the selection of a “kiss” emoji makes the skeletons of each of the avatars move to a position where the avatars kiss each other:
(a) In skeletal animation the nodes are called bones.
(b) The totality of a skeleton's animation is represented as a set of continuous curves defined by keyframes. A curve is formed for each aspect of each bone separately. There are x, y & z components of position, three or four components of rotation, and three components for scale. At each keyframe the time, the value and input+output tangents are defined
(c) Animation curves are authored by an artist working with a 3D animation software package. These curves are stored in a file on digital storage media. The curves are transformed to a format readable by the application and used in the animation playback.
(d) When animations are played back the curves are sampled at the screen refresh rate (e.g. 60 Hz) and the interpolated values are output to the transformation matrix of each bone, creating the illusion of movement.
(e) The application has a library of animation curve sets called animation clips. The application has a mapping of the animation clips triggered with each emoji read from user input.
(f) The user's input is processed by the application, and emoji symbols are detected from it. For each emoji for which a corresponding animation clip exists, the application queues the clip for playback.
(g) After all of the user input has been processed and the respective clips queued up for playback, the application triggers the playback. All the clips play back in sequence, one after each other.
   (i) The transition from one animation clip to the next is made smooth by crossfading.
   (ii) In crossfading, the curves of two animation clips overlap for a specified time, and the resulting value output to each parameter of each bone is formed by interpolating between the values of the two curves by a weight value. The weight value starts from completely preferring the curve that is being faded out at the beginning of the crossfade, and changes linearly to completely favor the curve being faded in.
   (iii) Should weight w of 0 completely favor the old curve a, and weight of 1 the new curve b and crossfade time be 0.33 seconds, the resulting value of one parameter of a skeleton bone during the crossfade would be specified by linear interpolation (with respect to time t, starting from 0 and going to 1):

value(t)=a(t)*(1−w)+b(t)*(w)

where w=t/0.33

A mathematical equation is used to determine how the surface of the avatar is affected by the movement of the skeleton in response to the emoji selection:
(a) It is Vertex skinning (other names for this would be enveloping or, more scientifically, Skeleton-Subspace Deformation.)
(b) In this methodology, the nodes of a skeleton are typically called bones.
(c) This is a process of animating vertices of a 3D-mesh by controlling them via a skeleton. If the bones of a skeleton move, the vertices move with them in certain relation.
(d) The default position of bones in the skeleton with respect to vertices in the mesh is called a bind-pose.
(e) At each vertex a number of bones with affluence to the vertex is specified. The weight of their subjective movement is also specified. The result displacement of the vertex from their position in the original mesh is interpolated from the combined weighted sum of displacements of the affecting bones from their bind-pose.

The Particles:
(a) Particles are point objects with a position and a velocity and a sprite attached. Particles in the 3D environment do NOT have a mesh-based geometry attached to them.
(b) Sprite can be any two-dimensional image, including an emoji.
(c) The size of the sprite can be controlled and the position of it is perspective-projected from the position in the 3D space.
(d) With sprite images resembling snowflakes or raindrops, particles can be used to simulate weather.
(e) With simple sprite images and a many particles, the combined effect of movement of the particles with the visual quality of their images can be used to simulate clouds, smoke, fire or streams of gases and liquids.

The Behavior of the Particles is Predefined:
(a) Particles have a position of birth, a life-time and a velocity curve.
(b) The position of birth is called the emitter.
(c) The emitter can either be a single point in space, an area, or even a plane or a cube. As long as it is definable by a function of x, y & z
(d) The emitter emits particles only during a defined time. (which can be forever).
(e) The particles are distributed randomly in the emitter area, and proceed from their place of birth according to their velocity curve.
(f) The velocity curve has a starting velocity as a vector, and any changes to it during the particle lifetime. Both can include probabilities, or in other words, randomness.

For example, the articles are removed from the simulation once their lifetime has expired. The movement of the particles is linked to the position of the animated characters:

In our invention, the sprites of particles are replaced by emoji symbols. They do not represent snowflakes, rain drops or cloud hazes.

The particle streams are bound to the environment by their emitters. The emitters are linked to positions in the animated characters, for example the mouth, eyes, hands or even the rectum.

For example, a particle emitter linked to the position of the mouth with a stream of particles shooting to the forward direction in the shape of a cone with high velocity can be used to simulate vomiting. (The particle lifetime would be short). A particle emitter could be linked to the palm of the hand with a stream of particles having low velocity and moving in the direction of the hand and all directions upward first, then gradually starting to disperse and float downward can be used to simulate a cloud of dust being released from a closed first that is opened while the hand moves. (In this case, the particle life-time would be long).

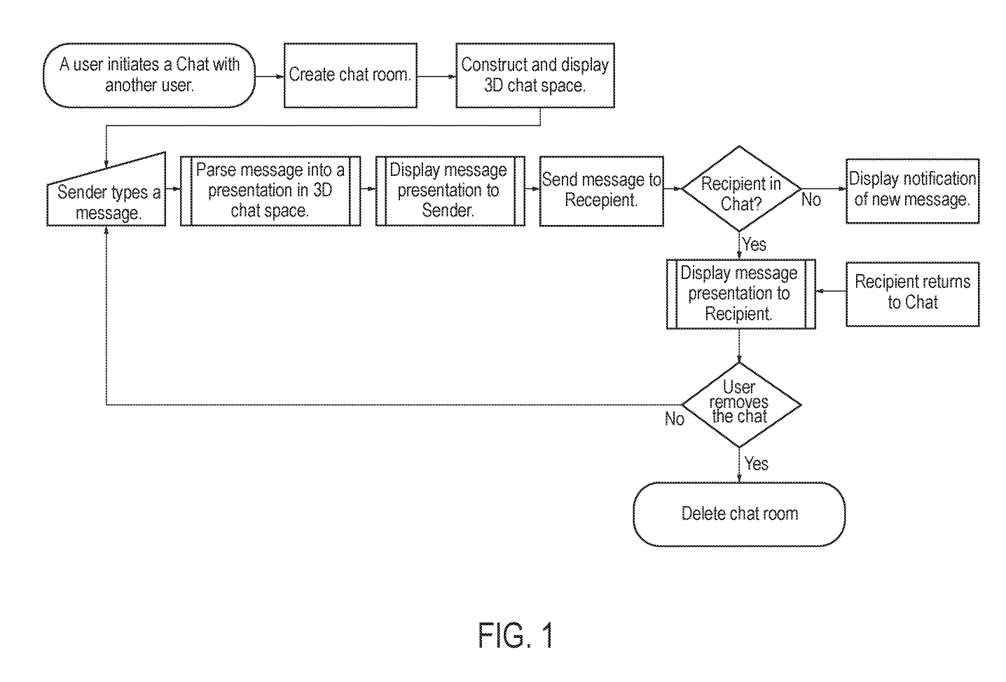

Turning now to the drawings, FIG. 1 is an overview of the messaging method of the present invention. The method begins with the user (first party) initiating a Chat with another user (second party). A Chat room is created by the server and the 3D chat space is constructed and displayed.

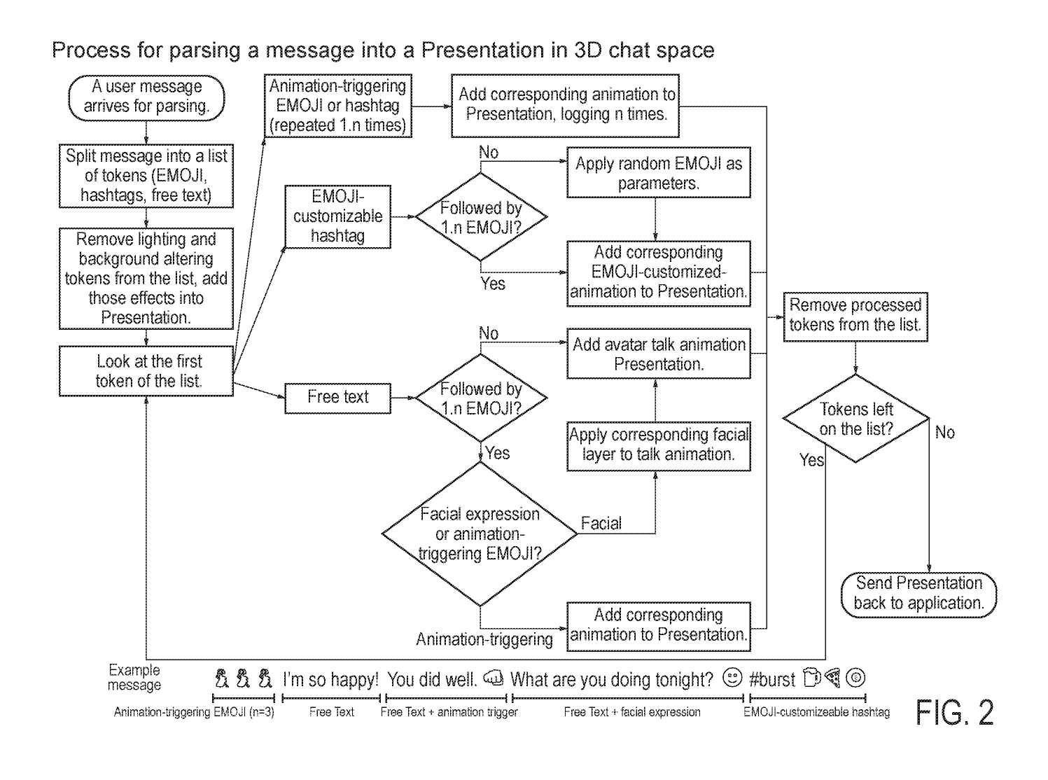

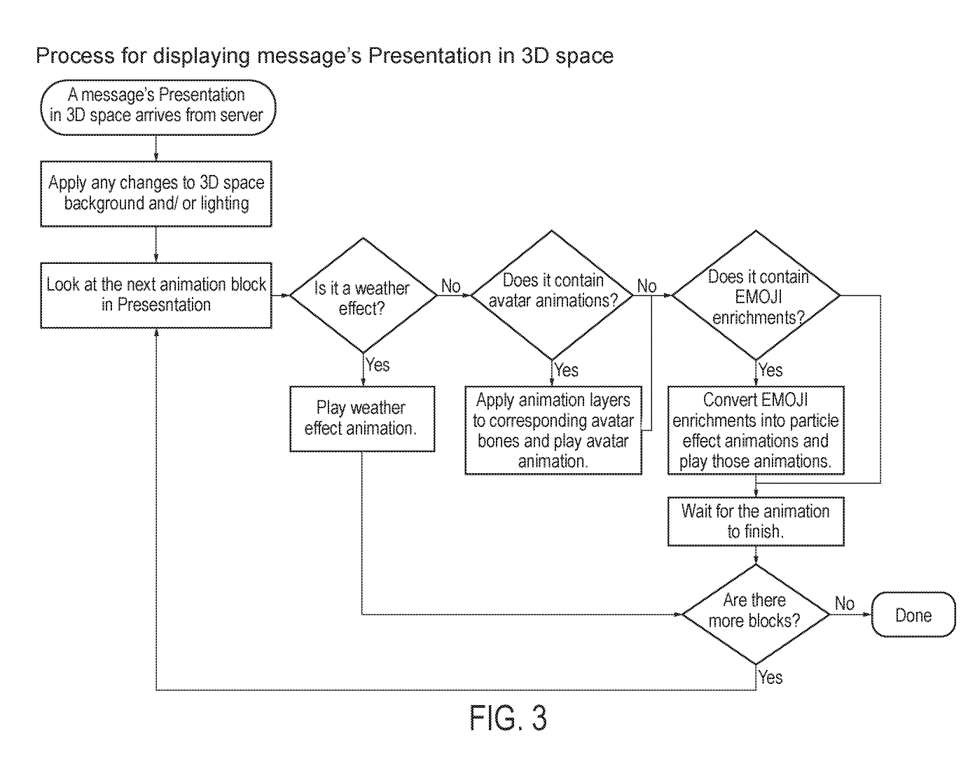

Next, the first party types and sends a message to the server. The typed message is parsed into a message Presentation in the 3D chat space where animations corresponding to the tokens (EMOJI, hashtag or free text) are added by the server, as disclosed in detail in FIG. 2. The message Presentation is displayed to the first party sender where the added animations are played, as disclosed in detail in FIG. 3. The first party then sends the displayed message to the recipient.

If the recipient is not in the Chat, a notification of new message is displayed. If the second party recipient returns to the Chat, or has been in the Chat, the message Presentation is displayed to the second party including playing the added animations, as detailed in FIG. 3.

After the message Presentation is displayed to the second party, the second party can either type a message back to the first party, which message will be received by the server, parsed, displayed and sent as described by the process described above, or the second party can delete the chat room terminating the Chat.

The process for parsing a message into a message Presentation in a 3D chat space is illustrated in FIG. 2. An example of a message exchange being parsed is set forth in the bottom of FIG. 2. Three animation-triggering emoji (dancing girls) are sent by a first party in a message along with the free text (“I'm so happy!”). The receiving second party answers with free text (“You did well.”) and animation-trigger (a first bump). The first party responds with free text (“What are you doing tonight”) along with a facial expression (smiley face). The response of the second party is an EMOJI-customizable hashtag #burst plus three icons, a beer, a pizza slice and a bowling ball.

When a message arrives at the server for parsing, the message is split into a list of tokens (EMOJI, hashtags, free text) by the server. Lighting and background altering tokens are removed from the list and those effects are added to the message Presentation by the server.

The first token on the list is examined by the server to determine whether it is an animation-triggering EMOJI or a hashtag. If an animation-triggering EMOJI or hashtag is present, the corresponding animation is added to the message Presentation by the server.

That process is repeated n times, once for each animation-triggering EMOJI or hashtag in the message being parsed. In this example, where three “dancing girl” EMOJI's are present, n=3 and this portion of the process would be repeated three times.

After all three animation-triggering EMOJIs or hashtags have been processed, the processed tokens are removed from the list by the server and a determination is made by the server as to whether any tokens remain on the list.

If tokens remain on the list, the next token on the list is examined by the server. If that token is an EMOJI-customizable hashtag, for example, a determination is made by the server as to whether the hashtag is followed by one or more EMOJI. If it is, the corresponding EMOJI-customized-animation is added to the message Presentation by the server. If not, random EMOJI are added to the message Presentation by the server as parameters which are then used to add the corresponding EMOJI-customized-animation to the message Presentation.

Those processed tokens are removed from the list and a determination as to whether any tokens remain on the list is made by the server. If tokens remain on the list, the next token on the list is examined. If that token consists of free text, the token is examined to see if the free text is followed by an EMOJI. If the free text is not followed by an EMOJI, an avatar talk animation is added to the message Presentation by the server.

If the free text is followed by an EMOJI, a determination is made as to whether the EMOJI is a facial expression or animation-triggering EMOJI. If it is a facial expression EMOJI, the corresponding facial layer is applied to the talk animation avatar in the message Presentation by the server. If the EMOJI in the token being parsed is animation-triggering, the corresponding animation is added to the message Presentation by the server.

That processed token is removed from the list and a determination as to whether any tokens remain on the list is made by the server. If no tokens remain on the list, the message Presentation is sent back to be displayed to the sender (FIG. 1)

FIG. 3 illustrates the process for displaying a message Presentation in 3D space. When a message Presentation in 3D space arrives at the server, any changes in 3D space in background and/or lighting are applied. The server then looks at the first animation block in the Presentation.

If the animation block is a weather effect, for example, the weather effect animation is played. If not, a determination is made as to whether the block contains avatar animations.

If avatar animations are present, animation layers corresponding to the bones are applied and the avatar animation is played. If there are no avatar animations present or the playing avatar animation is present, the server ascertains whether the block contains EMOJI enrichments. If it does, the EMOJI enrichments are converted into particle effects and those particle effects are played.

If weather animation effects, avatar animation or particle effects animation are playing, the animation block is removed from the message Presentation. If there are additional blocks in the message Presentation, the above process is repeated until each animation block in the message has been processed.

While only a single preferred embodiment of the present invention has been disclosed for purposes of illustration, it is obvious that many modifications and variations could be made thereto. It is intended to cover all of those modifications and variations which fall within the scope of the present invention, as defined by the following claims.

We claim:

1. A method of using EMOJI to control a 3D chat environment comprising the steps of:
(a) constructing and displaying a 3D chat space within which a first party and a second party may communicate;
(b) parsing a message entered by one party into a message Presentation in the 3D chat space including at least one animation-triggering token (EMOJI, hashtag or free text) by adding animation corresponding to the token to the message Presentation;
(c) sending the message Presentation to the second party; and
(d) displaying the message Presentation to the second party, including playing the animation corresponding to the token.

2. The method of claim 1 further comprising that step of displaying the message Presentation to the first party, including playing animation corresponding to the token, before the message Presentation is sent to the second party.

3. The method of claim 1 wherein the step of parsing a message comprises the steps of:
(e) splitting the message to be parsed into a list of tokens;
(f) associating the tokens on the list with a corresponding animation;
(g) forming the message Presentation of the corresponding animation for each of the tokens on the list;
(h) displaying the message Presentation.

4. The method of claim 1 wherein the step of displaying the message Presentation comprises the steps of:
(i) determining if the animation block in the message Presentation includes a weather effect; and
(j) if the animation block in the message Presentation includes a weather effect, playing the weather effect animation.

5. The method of claim 1 wherein the step of displaying the message Presentation comprises the steps of:
(k) determining if the animation includes an avatar animation; and
(l) if the animation includes an avatar animation, applying animation layers to corresponding avatar bones and playing the avatar animation.

6. The method of claim 1 wherein the step of displaying the message Presentation comprises the steps of:
(m) determining if the animation includes EMOJI enrichments;
(n) if the animation includes EMOJI enrichments, converting the EMOJI enrichments into particle effect animations and playing the particle effect animations.

7. The method of claim 2 wherein the step of displaying the message Presentation comprises the steps of:
(o) determining if the animation block in the message Presentation includes a weather effect; and
(p) if the animation block in the message Presentation includes a weather effect, playing the weather effect animation.

8. The method of claim 2 wherein the step of displaying the message presentation comprises the steps of:
(q) determining if the animation includes an avatar animation; and
(r) if the animation includes an avatar animation, applying animation layers to corresponding avatar bones and playing the avatar animation.

9. The method of claim 2 wherein the step of displaying the message presentation comprises the steps of:
(s) determining if the animation includes EMOJI enrichments;
(t) if the animation includes EMOJI enrichments, converting the EMOJI enrichments into particle effect animations and playing the particle effect animations.

10. The method of claim 1 further comprising the steps of:
(u) initiating a chat by the first party; and
(v) creating a chat room.

11. The method of claim 1 further comprising the steps of:
(w) determining if the second arty is still in the chat after the message Presentation is sent; and
(x) if the receiving party is not still in the chat, waiting until the receiving party returns to the chat before displaying the message Presentation to the second party.

12. The method of claim 3 further comprising the steps of:
(y) determining if the token includes an animation-triggering EMOJI or hashtag;
(z) if the token includes an animation-triggering EMOJI or hashtag; adding corresponding animation to the message Presentation.

13. The method of claim 3 further comprising the steps of:
(aa) determining if the token includes an EMOJI-customizable hashtag;
(bb) if the token includes an EMOJI-customizable hashtag, determining if the EMOJI-customizable hashtag is followed by an EMOJI;
(cc) if the customizable hashtag is followed by an EMOJI, adding animation corresponding to the EMOJI to the message Presentation.

14. The method of claim 13 further comprising the step of applying random EMOJI as parameters, if the customizable hashtag is not followed by an EMOJI.

15. The method of claim 3 further comprising the steps of:
(dd) determining if the token includes free text;
(ee) if the token includes free text, determining if the free text is followed by an EMOJI;
(ff) if the free text is followed by an EMOJI, adding animation corresponding to the EMOJI to the message Presentation.

16. The method of claim 15 further comprising the steps of:
(gg) determining if the free text includes a facial expression, and if the free text includes a facial expression, applying corresponding facial layer to talk animation and adding avatar talk animation to message Presentation.

17. The method of claim 13 further including the steps of adding avatar talk animation to message Presentation if the free text is not followed by an EMOJI.

18. The method of claim 13 further comprising the step of removing the lighting and background altering tokens from the list and adding same into the message Presentation.

19. The method of claim 3 wherein the steps of splitting the message to be parsed into a list of tokens; associating each of the tokens on the list with a corresponding animation; and forming the message Presentation of the corresponding animations for each of the tokens on the list, are repeated by the server for each token on the list.

20. The method of claim 6 wherein the particle effect animation includes an EMOJI.

21. The method of claim 9 wherein the particle effect animation includes an EMOJI.
